(19) United States
(12) Patent Application Publication
(10) Pub. No.: US 2025/0386144 A1
(43) Pub. Date: Dec. 18, 2025

(54) SPEAKER

(71) Applicant: AAC Microtech (Changzhou) Co., Ltd., Changzhou City (CN)

(72) Inventor: Chao Zhang, Changzhou (CN)

(21) Appl. No.: 19/006,272

(22) Filed: Dec. 31, 2024

Related U.S. Application Data
(63) Continuation of application No. PCT/CN2024/099722, filed on Jun. 18, 2024.

(51) Int. Cl. H04R 7/18; H04R 7/04; H04R 9/02; H04R 9/06

(52) U.S. Cl. CPC H04R 7/18; H04R 7/04; H04R 9/025; H04R 9/06; H04R 2207/021

(57) ABSTRACT

A speaker includes a vibration system and a magnetic circuit system driving the vibration system to vibrate and sound. The vibration system includes a voice membrane and a voice coil driving the voice membrane to vibrate. The voice membrane includes a diaphragm and a dome fixed with the diaphragm, the dome includes a main body and a positioning portion bending and extending from an edge of the main body, the positioning portion is used for ensure concentricity of the diaphragm when the diaphragm is integrally formed with the dome. Compared with the related art, the speaker disclosed by the present disclosure could improve the reliability.

### FIELD OF THE INVENTION

The invention relates to the technical field of electro-acoustic transducers, in particular to speaker.

### BACKGROUND

In recent years, with the rapid development of mobile communication technology, consumers are increasingly using mobile communication devices with voice functions, such as portable phones, handheld game consoles, laptops, notebook computers, multimedia players, and other devices capable of communication through public or private communication networks. As the playback device for voice functions, an internal vibration system of the speaker is directly related to the reliability of the speaker.

A speaker of the related art includes a diaphragm and a dome fixed with the diaphragm by gluing. A concentricity of the diaphragm and dome cannot be guaranteed, and the glue used for gluing is prone to be lacking or overflowing, which leads to a large degree of wobbling of the speaker.

Therefore, it is desired to provide a novel speaker to solve the above problems.

### SUMMARY

The present disclosure is to provide a speaker with high assembly precision and good stability.

For achieving the object mentioned above, the disclosure provides a speaker including a vibration system and a magnetic circuit system driving the vibration system to vibrate and sound. The vibration system includes a voice membrane and a voice coil driving the voice membrane to vibrate. The voice membrane includes a diaphragm and a dome fixed with the diaphragm, the dome includes a main body and a positioning portion bending and extending from an edge of the main body, the positioning portion is used for ensure concentricity of the diaphragm when the diaphragm is integrally formed with the dome.

Further, the main body includes a pair of first edges, a pair of second edges adjacent to the pair of first edges, and arcuate edges, each of the arcuate edges is connected with one of the pair of first edges and one of the pair of second edges that are adjacent.

Further, the positioning portion is arranged on at least one of the pair of first edges, one of the pair of second edges, or one of the arcuate edges.

Further, a ratio of a length of the positioning portion extending along the edge of the main body to a circumference of the main body is greater than 5% and less than or equal to 100%.

Further, a length of the positioning portion bending and extending from the edge of the main body is greater than 0.05 mm.

Further, the diaphragm includes a suspension, a first fixing portion connected with an inner peripheral edge of the suspension, a second fixing portion connected with an outer peripheral edge of the suspension, the main body is fixed with the first fixing portion, the positioning portion is arranged at a junction of the suspension and the first fixing portion.

Further, a process of the integrated forming includes one of gluing, hot pressing and injection molding.

Further, the magnetic circuit system includes a yoke, a primary magnet located above the yoke, a secondary magnet spaced apart from the primary magnet, a pole plate located above the primary magnet, and an upper plate surrounding the primary magnet and above the secondary magnet.

Further, the yoke includes a first projection bending and extending towards the upper plate, the first projection is fixed with the upper plate, the upper plate includes a second projection bending and extending towards the voice membrane, the second projection is fixed with the second fixing portion.

Further, the speaker includes an electrical connection member provided on the magnetic circuit system, the electrical connection member is fixed with the upper plate, the voice coil is electrically connected to an external circuit via the electrical connection member.

### BRIEF DESCRIPTION OF THE DRAWINGS

In order to explain the technical solutions of the embodiments of the present disclosure more clearly, accompanying drawings used to describe the embodiments are briefly introduced below. It is evident that the drawings in the following description are only concerned with some embodiments of the present disclosure. For those skilled in the art, in a case where no inventive effort is made, other drawings may be obtained based on these drawings.

FIG. 1 is an isometric view of a speaker of the present disclosure;

FIG. 2 is an exploded view of the speaker of the present disclosure;

FIG. 3 is an isometric view of a voice membrane in the speaker of the present disclosure;

FIG. 4 is a cross-sectional view along the line A-A in FIG. 1.

### DESCRIPTION OF THE EMBODIMENTS

The present disclosure will be further illustrated with reference to the accompanying drawings. It shall be noted that the elements of similar structures or functions are represented by like reference numerals throughout the figures. The embodiments described herein are not intended as an exhaustive illustration or description of various other embodiments or as a limitation on the scope of the claims or the scope of some other embodiments that are apparent to one of ordinary skills in the art in view of the embodiments described in the application. In addition, an illustrated embodiment need not have all the aspects or advantages shown.

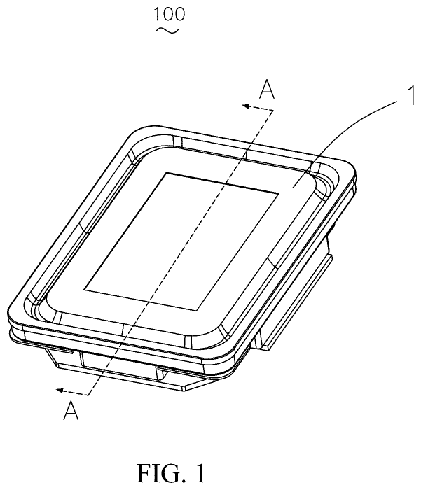

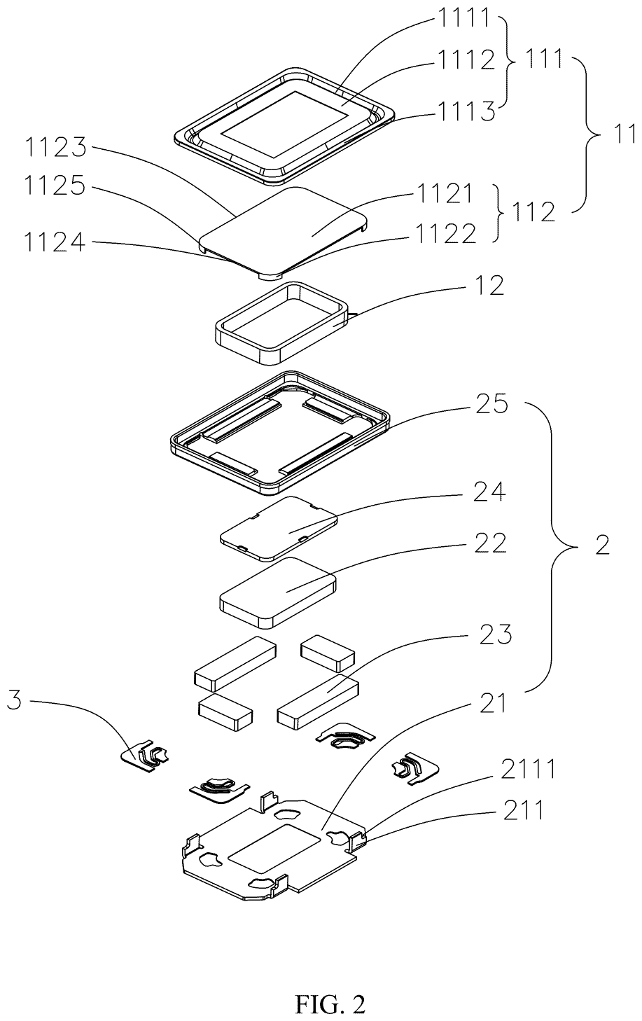

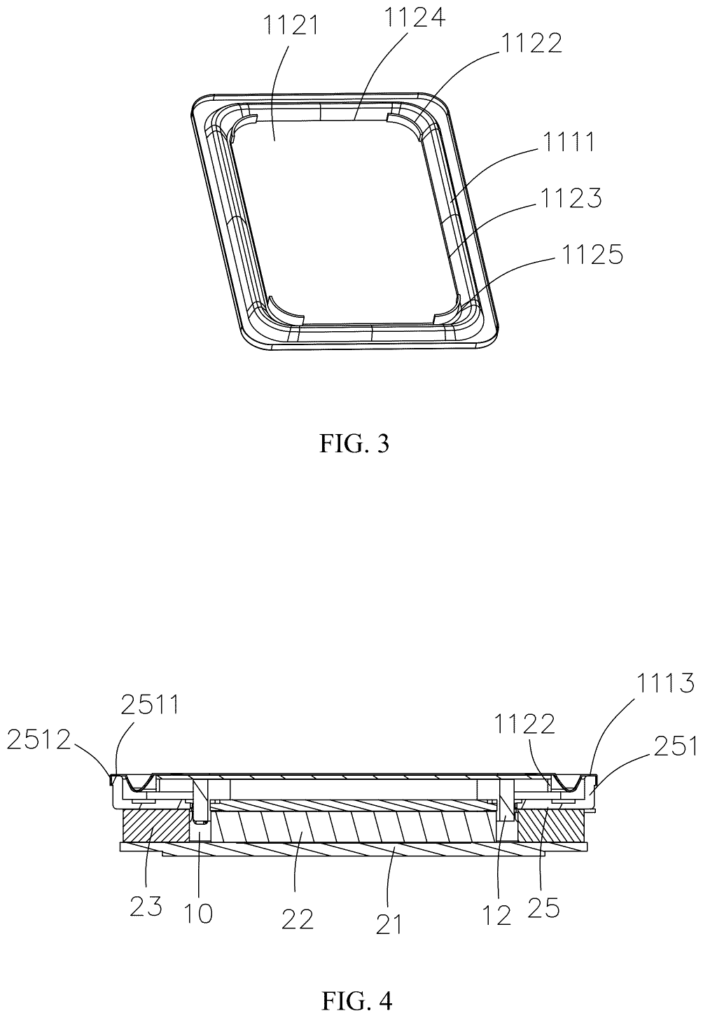

As shown in the FIGS. 1-4, the present invention discloses a speaker 100, which includes a vibration system 1 and a magnetic circuit system 2 driving the vibration system 1 to vibrate and sound.

The vibration system 1 includes a voice membrane 11 and a voice coil 12 driving the voice membrane 11 to vibrate. The voice membrane 11 includes a diaphragm 111 and a dome 112 fixed with the diaphragm 111, the diaphragm 111 includes a suspension 1111, a first fixing portion 1112 connected with an inner peripheral edge of the suspension 1111, a second fixing portion 1113 connected with an outer peripheral edge of the suspension 1111. The dome 112 is fixed with the first fixing portion 1112.

The dome 112 includes a main body 1121 and a positioning portion 1122 bending and extending from an edge of the main body 1121, the positioning portion 1122 is used for ensure concentricity of the diaphragm 111 when the diaphragm 111 is integrally formed with the dome 112. A length of the positioning portion 1122 bending and extending from the edge of the main body 1121 is greater than 0.05 mm, as an improvement, the length of the positioning portion 1122 bending and extending from the edge of the main body is 0.4 mm.

The main body 1121 is fixed with the first fixing portion 1112. The main body 1121 includes a pair of first edges 1123, a pair of second edges 1124 adjacent to the pair of first edges 1123, and arcuate edges 1125, each of the arcuate edges is connected with one of the pair of first edges 1123 and one of the pair of second edges 1124 that are adjacent. The positioning portion 1122 is arranged on at least one of the pair of first edges 1123, one of the pair of second edges 1124, or one of the arcuate edges 1125. Preferably in this embodiment, there is a plurality of positioning portions 1122, the plurality of positioning portions 1122 are arranged on four of the arcuate edges 1125.

The plurality of positioning portions 1122 are located at a junction of the suspension 1111 and the first fixing portion 1112, and a ratio of a length of each of the plurality of positioning portions 1122 extending from the edge of the main body 1121 to the perimeter of the main body 1121 is greater than 5% and less than or equal to 100%, and preferably in this embodiment, the ratio of the length of each of the plurality of positioning portions 1122 extending from the edge of the main body 1121 to the perimeter of the main body 1121 is 20.9%.

A process of the integrated forming includes one of gluing, hot pressing and injection molding. Preferably in this embodiment, the diaphragm 111 and the dome 112 are integrally molded by glue.

The plurality of positioning portions 1122 are provided in conjunction with a recessed portion of the voice membrane mold when the diaphragm 111 and the dome 112 are integrally formed to ensure the concentricity of the diaphragm 111 and the dome 112, while when the diaphragm 111 and the dome 112 are fixed by glue, the better concentricity of the diaphragm 111 and the dome 112 makes it possible to reduce the glue used for gluing. In addition, the preferred material of the glue is bonding agent, a thin layer of glue is sprayed on a surface of the bonding agent when gluing which could avoid the situation of lack of glue and overflow of glue. If hot pressing and injection molding processes are used, since hot pressing and injection molding in the integrally molded process do not require glue and bonding agent, there is no lack of glue or overflow of glue, which could also effectively improve the assembly precision and consistency of the speaker.

The magnetic circuit system 2 includes a yoke 21, a primary magnet 22 located above the yoke 21, a secondary magnet 23 spaced apart from the primary magnet 22, a pole plate 24 located above the primary magnet 22 and attached to the primary magnet 22, and an upper plate 25 surrounding the primary magnet 22 and located above the secondary magnet 23, the upper plate 25 is attached to the secondary magnet 23, the primary magnet 22 and the secondary magnet 23 form a magnetic gap 10, the voice coil 12 is partially inserted into the magnetic gap 10, the second fixing portion 1113 is fixed with the upper plate 25.

The yoke 21 includes a first projection 211 bending and extending towards the upper plate 25, the first projection 211 is fixed with the upper plate 25, the first projection 211 is used for the limitation of the secondary magnet 23.

The upper plate 25 includes a second projection 251 bending and extending towards the voice membrane 11, the second projection 251 is fixed with the second fixing portion 1113. The second projection 251 includes a top portion 2511 and a sidewall 2512, the top portion 2511 and the sidewall 2512 are fixed with the second projection 1113 to ensure the stability of the speaker.

An electrical connection member 3 is provided on the magnetic circuit system 2, the electrical connection member 3 is fixed with the upper plate 25, the voice coil 12 is electrically connected to an external circuit via the electrical connection member 3. The first projection 211 is provided with an avoidance portion 2111 used for avoiding the electrical connection member 3.

Compared with the related technology, the present invention provides the speaker including the vibration system and the magnetic circuit system driving the vibration system to vibrate and sound, the vibration system includes the voice membrane and the voice coil driving the voice membrane to vibrate, the voice membrane includes the diaphragm and the dome fixed with the diaphragm, the dome includes the main portion and the positioning portion bending and extending along the edge of the main portion, the positioning portion is used for ensure concentricity of the diaphragm when it is integrally formed with the dome. The present invention provides the positioning portion at the edge of the dome, which could effectively improve the assembly precision and consistency of the speaker and improve the reliability of the speaker.

It should be appreciated by those skilled in the art that various modifications are possible without departing from the spirit or scope of the present invention. The embodiments illustrated above should not be interpreted as limits to the present invention, and the scope of the invention is to be determined by reference to the claims that follow.

What is claimed is:

1. A speaker comprising:
a vibration system, comprising a voice membrane and a voice coil driving the voice membrane to vibrate; and
a magnetic circuit system driving the vibration system to vibrate and sound; wherein
the voice membrane comprises a diaphragm and a dome fixed with the diaphragm, the dome comprises a main body and a positioning portion bending and extending from an edge of the main body, the positioning portion is used for ensure concentricity of the diaphragm when the diaphragm is integrally formed with the dome.

2. The speaker as described in claim 1, wherein the main body comprises a pair of first edges, a pair of second edges adjacent to the pair of first edges, and arcuate edges, each of the arcuate edges is connected with one of the pair of first edges and one of the pair of second edges that are adjacent.

3. The speaker as described in claim 2, wherein the positioning portion is arranged on at least one of the pair of first edges, one of the pair of second edges, or one of the arcuate edges.

4. The speaker as described in claim 1, wherein a ratio of a length of the positioning portion extending along the edge of the main body to a circumference of the main body is greater than 5% and less than or equal to 100%.

5. The speaker as described in claim 1, wherein a length of the positioning portion bending and extending from the edge of the main body is greater than 0.05 mm.

6. The speaker as described in claim 1, wherein the diaphragm comprises a suspension, a first fixing portion connected with an inner peripheral edge of the suspension, a second fixing portion connected with an outer peripheral edge of the suspension, the main body is fixed with the first fixing portion, the positioning portion is arranged at a junction of the suspension and the first fixing portion.

7. The speaker as described in claim 1, wherein a process of the integrated forming comprises one of gluing, hot pressing and injection molding.

8. The speaker as described in claim 6, wherein the magnetic circuit system comprises a yoke, a primary magnet located above the yoke, a secondary magnet spaced apart from the primary magnet, a pole plate located above the primary magnet, and an upper plate surrounding the primary magnet and above the secondary magnet.

9. The speaker as described in claim 8, wherein the yoke comprises a first projection bending and extending towards the upper plate, the first projection is fixed with the upper plate, the upper plate comprises a second projection bending and extending towards the voice membrane, the second projection is fixed with the second fixing portion.

10. The speaker as described in claim 8 further comprising an electrical connection member provided on the magnetic circuit system, the electrical connection member is fixed with the upper plate, the voice coil is electrically connected to an external circuit via the electrical connection member.
